(19) United States
(12) Patent Application Publication
(10) Pub. No.: US 2017/0216873 A1
(43) Pub. Date: Aug. 3, 2017

(54) APPARATUS AND METHOD FOR FORMING MICROBUBBLES IN A MIXED MULTI-COMPONENT REACTIVE MATERIAL

(71) Applicant: Graco Minnesota Inc., Minneapolis, MN (US)

(72) Inventors: Steven R. Sinders, North Canton, OH (US); Michael P. Bozzelli, Akron, OH (US); Matthew E. Givler, North Canton, OH (US); Malcolm C. Larsen, Canton, GA (US); William R. Anderson, Canton, OH (US)

(21) Appl. No.: 15/331,400

(22) Filed: Oct. 21, 2016

Related U.S. Application Data
(60) Provisional application No. 62/288,603, filed on Jan. 29, 2016.

(51) Int. Cl. B05C 5/02; B01F 15/02; B01F 15/06; B05C 5/00; B01F 3/04

(52) U.S. Cl. CPC B05C 5/0233; B05C 5/001; B01F 3/04248; B01F 3/04531; B01F 15/066; B01F 15/0243; B01F 15/0292; B01F 2003/04709; B01F 2003/04333; B01F 2015/061

(57) ABSTRACT

An apparatus for preparing a liquid material containing microbubbles includes a dispensing nozzle and a first positive displacement gas pump. The dispensing nozzles includes a material mixing channel, a rotary gas diffuser positioned in the material mixing channel, and a rotary mixer positioned in the material mixing channel downstream of the rotary gas diffuser. The rotary gas diffuser and the rotary mixer rotate about a common axis of rotation. The first positive displacement pump has a first gas outlet opening to the material mixing channel, which is directed at an outer circumference of the rotary gas diffuser.

### CROSS-REFERENCE TO RELATED APPLICATION(S)

This application claims the benefit of U.S. Provisional Application No. 62/288,603 filed Jan. 29, 2016 for “Forming Micro Bubbles in A Mixed Two Component Reactive Material” by Steven R. Sinders, Michael P. Bozzelli, Matthew E. Givler, Malcom C. Larsen, and William R. Anderson, which is hereby incorporated by reference in its entirety.

### BACKGROUND

The present invention relates generally to the preparation of materials and, more particularly, to an apparatus and method for forming microbubbles in a mixed two-component reactive material.

The ability to form, control the amount of, and evenly distribute microbubbles in a material, particularly a mixed two-component reactive material, is highly desired for the production of in-place gaskets, sound deadening material, and adhesives, well as other applications where material weight can be reduced with the addition of microbubbles without negatively impacting the desired material properties. There is a particular need for entraining a predetermined amount of a gas, evenly distributed as microbubbles, in a small volume of material (e.g., a bead of an adhesive) at a point of dispensing. Prior art methods employing bulk conditioning processes, in which gas is injected into large volumes of one component (e.g., base material) of a two-component reactive material, require constant monitoring and recirculation to keep the gas evenly distributed. The addition of gas changes the volume of the base material. In order to maintain a proper ratio of the two components, an amount of a second component added to form the two-component reactive material must be adjusted. Each time the amount of gas entrapped changes, the amount of the second component added, must change accordingly. An improper ratio of the two-components can adversely impact the properties of the mixed material.

Bulk conditioning processes, in which gas is injected into large volumes of material, can also result in an uneven distribution of gas and an increased potential for forming large pockets of gas. Uneven mixing and large pockets of gas can be unsuitable for dispensing small volumes of material. In particular, when the material is dispensed as a bead of adhesive, a large bubble of gas would render the material useless for its intended purpose.

### SUMMARY

An apparatus for preparing a liquid material containing microbubbles includes a dispensing nozzle and a first positive displacement gas pump. The dispensing nozzles includes a material mixing channel, a rotary gas diffuser positioned in the material mixing channel, and a rotary mixer positioned in the material mixing channel downstream of the rotary gas diffuser. The rotary gas diffuser and the rotary mixer rotate about a common axis of rotation. The first positive displacement pump has a first gas outlet opening to the material mixing channel, which is directed at an outer circumference of the rotary gas diffuser.

A method of preparing and applying a liquid material containing microbubbles includes delivering a first liquid material into a common material mixing channel of a dispensing nozzle, segmenting the first liquid material into discrete portions by flowing the first liquid material through slots, injecting a predetermined amount of gas into the discrete portions of the first liquid material in the slots of the rotary gas diffuser, and mixing the first liquid material and the gas in the dispensing nozzle.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is a block diagram of an apparatus for producing and dispensing material containing microbubbles.

FIG. 2 is a flow chart for a method of preparing and dispensing a liquid material containing microbubbles.

FIG. 3 is a schematic cross-sectional view of one embodiment of the apparatus of FIG. 1.

FIG. 4 is a top schematic cross-sectional view of a portion of the apparatus where gas is injected into a material stream, taken along the 3-3 line of FIG. 3.

FIG. 5 is a perspective view of a rotary gas diffuser and rotary mixer shown in isolation.

FIG. 6 is a schematic cross-sectional view of another embodiment of the apparatus of FIG. 1.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

The disclosed apparatus and method can be used for a wide variety of applications, including, but not limited to, the preparation of a two-component reactive material (e.g., as used for the production of adhesives) having evenly distributed gas microbubbles—small enough to be entrained in a small bead of material applied to a surface. The addition of gas microbubbles to a material can reduce the amount of raw materials needed and reduce weight of the produced material without negatively impacting desired material properties (e.g., adhesion bond strength).

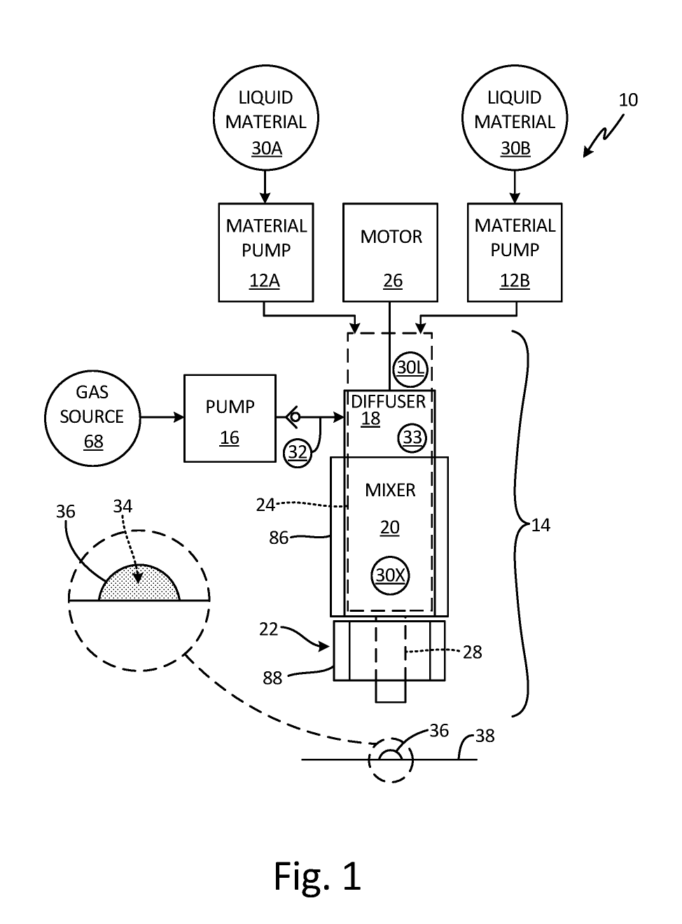

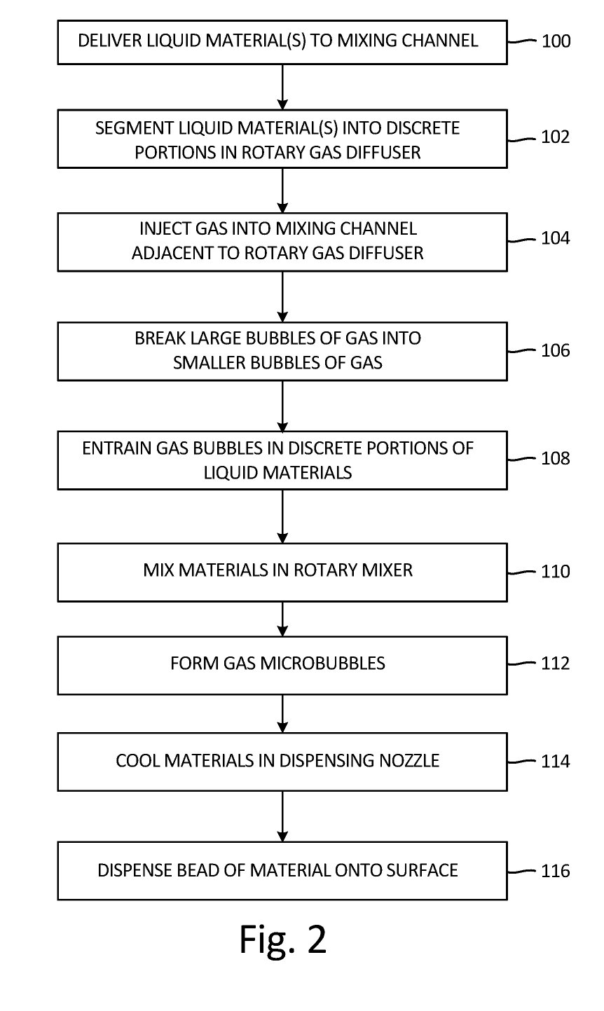

FIGS. 1 and 2 provide a block diagram of one embodiment of apparatus 10 and flow chart of a method used for preparing and dispensing a material containing gas microbubbles. As shown in FIG. 1, apparatus 10 can include one or more material pumps 12A, 12B, dispensing nozzle 14, and positive displacement pump 16. Dispensing nozzle 14 can house rotary gas diffuser 18, rotary mixer 20, and nozzle tip 22. Rotary gas diffuser 18 and rotary mixer 20 can be positioned within a common material mixing channel 24 and can both be driven by motor 26. Nozzle tip 22 can have dispensing channel 28 in fluid communication with mixing channel 24.

During operation, one or more liquid materials 30A, 30B can be delivered directly into mixing channel 24 of dispensing nozzle 14 by pump(s) 12A, 12B (FIG. 2, step 100). Materials 30A and 30B are referred to collectively as combined material 30L (even though an amount of mixing of materials 30A and 30B upon entering mixing channel 24 can be insignificant). Combined material 30L can be segmented into discrete portions in rotary gas diffuser 18 (FIG. 2, step 102). As combined material 30L flows through rotary gas diffuser 18, gas 32 can be injected into mixing channel 24 adjacent an outer circumference of rotary gas diffuser 18 (FIG. 2, step 104). As gas 32 is injected, larger bubbles of gas 32 can be broken into smaller gas bubbles 33 by rotary gas diffuser 18 (FIG. 2, step 106). Additionally, gas 32 can be entrained in the discrete portions of combined material 30L (FIG. 2, step 108), forming material 30X (combined material 30L plus gas 32). Material 30X can then be mixed in dispensing nozzle 14 by rotary mixer 20 to evenly distribute the bubbles of gas and form gas microbubbles 34 (FIG. 2, steps 110 and 112). During mixing as well as dispensing, material 30X can be cooled in dispensing nozzle 14 to slow a thermal reaction (FIG. 2, step 114). Following mixing, a bead 36 (or ribbon or other small volume) of material 30X (shown in enlarged detail in FIG. 1) can be dispensed through nozzle tip 22 onto a surface 38 (FIG. 2, step 116). Although discussed as method for preparing a two-part reactive material, it will be understood by one of ordinary skill in the art that apparatus 10 and steps 100-116 can be adapted for forming microbubbles in a single material or reactive materials with more than two parts.

In dispensing small volumes of material, such as bead 36, it can be necessary to finely control the amount, size, and distribution of gas bubbles, recognizing that a large volume of gas or large single bubble of gas can render the small volume of material useless. For example, in one embodiment an average width (e.g., diameter) of each of the gas microbubbles 34 can be less than 400 μm in a bead 36 having a height of 4-8 mm and a volume of gas 32 can be up to 50 percent of a total volume of 30× (equal to the sum of the volume of the gas microbubbles 34 and a volume of combined material 30L). In general, microbubbles 34 can range in size, having a width (e.g., diameter) of up to one millimeter, while the total volume of gas can be widely varied depending on the material and application. Apparatus 10 provides a beneficial alternative to bulk conditioning processes, in which air is injected into large volumes of materials, commonly resulting in an uneven distribution of gas and an increased potential for forming large pockets of gas. Apparatus 10 can provide direct metering of gas 32 and material mixing at the point of dispensing, thereby delivering a consistent foam structure and material density that can be adjusted as necessary without having to return material 30A and/or 30B to a mixing vessel for further processing. Additionally, the injection of gas 32 into mixing channel 24, containing both materials 30A and 30B (as combined material 30L), can eliminate the need to adjust a ratio of materials 30A and 30B based on changes in injection of gas 32. When gas 32 is injected into only one of the materials (30A or 30B), the volume of the material receiving gas 32 changes, necessitating a change in an amount of the second material added in order to maintain desired material properties of material 30X.

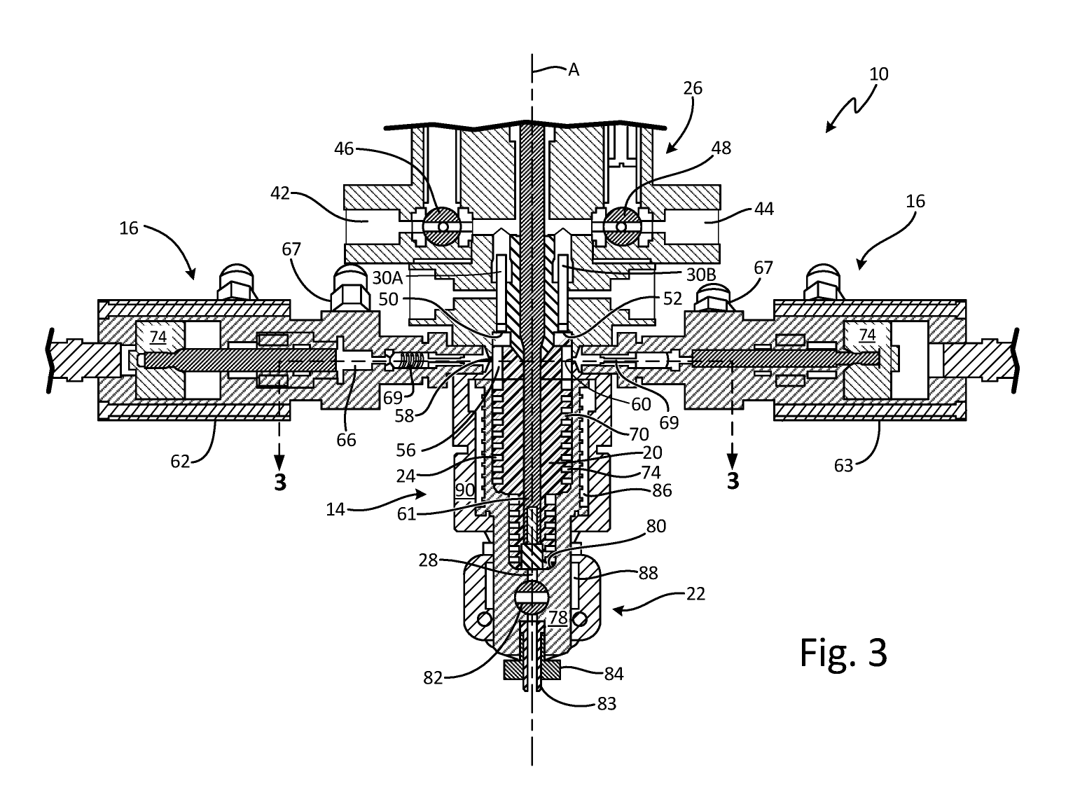

The inner workings of apparatus 10 are illustrated in FIG. 3, which is a cross-sectional view of one embodiment of apparatus 10. As shown in FIG. 3, apparatus 10 can be used to prepare a two-component reactive material, using both material pumps 12A and 12B (FIG. 1) to deliver both materials 30A and 30B to dispensing nozzle 14. Materials 30A and 30B can enter apparatus 10 at material inlets 42 and 44, respectively. On/off valves 46 and 48 can be used to permit or suspend a flow of materials 30A and 30B through apparatus 10. Flow of materials 30A and 30B into apparatus 10 can be adjusted with a material flow controller (not shown). Alternatively, the flow of materials 30A and 30B can be controlled by adjusting an orifice size and/or pressure from material pumps 12A and 12B. A ratio of material 30A to material 30B can be set as appropriate for varying applications. While apparatus 10 may be uniquely suited for two-part reactive materials (e.g., two-part reactive silicones, polyurethanes, or polysulfides, as commonly used for bonding or sealant applications), apparatus 10 can be used for the preparation of a variety of materials, including both high and low viscosity materials, and a variety of applications. Furthermore, apparatus 10 can be used to entrain microbubbles 34 in a single material 30A or more than two reactive materials. Materials 30A and 30B can be delivered simultaneously to mixing channel 24 of dispensing nozzle 14 through material outlets 50 and 52, respectively, which can be open to mixing channel 24 directly upstream of rotary gas diffuser 18. Once in mixing channel 24, materials 30A and 30B are free to mix, forming combined material 30L. Although large portions of materials 30A and 30B may remain segregated in an upstream space (unnumbered) between material outlets 50 and 52 and rotary gas diffuser 18, as well as through rotary gas diffuser 18, once materials 30A and 30B have entered material mixing channel 24, they are referred to as combined material 30L.

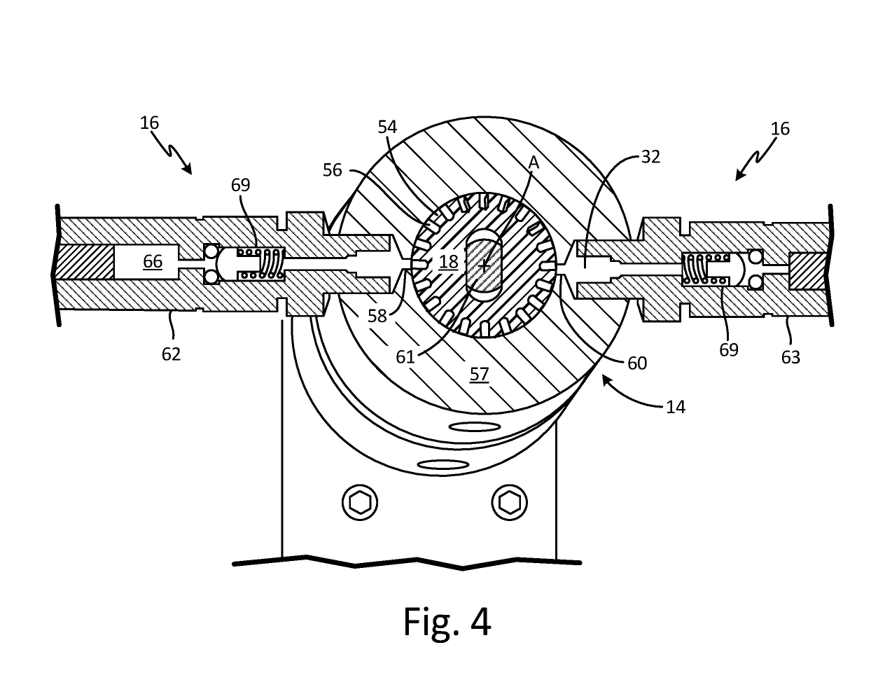

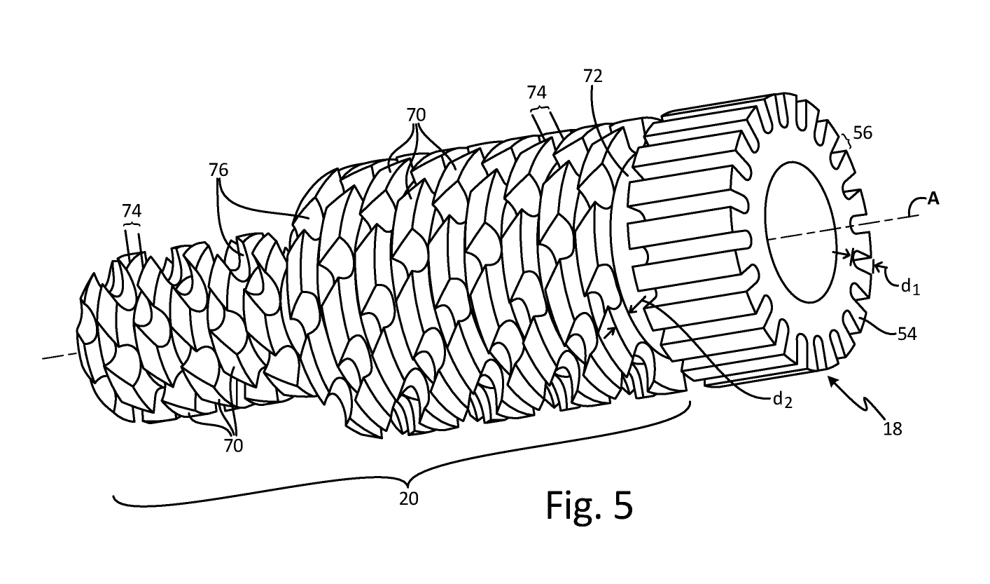

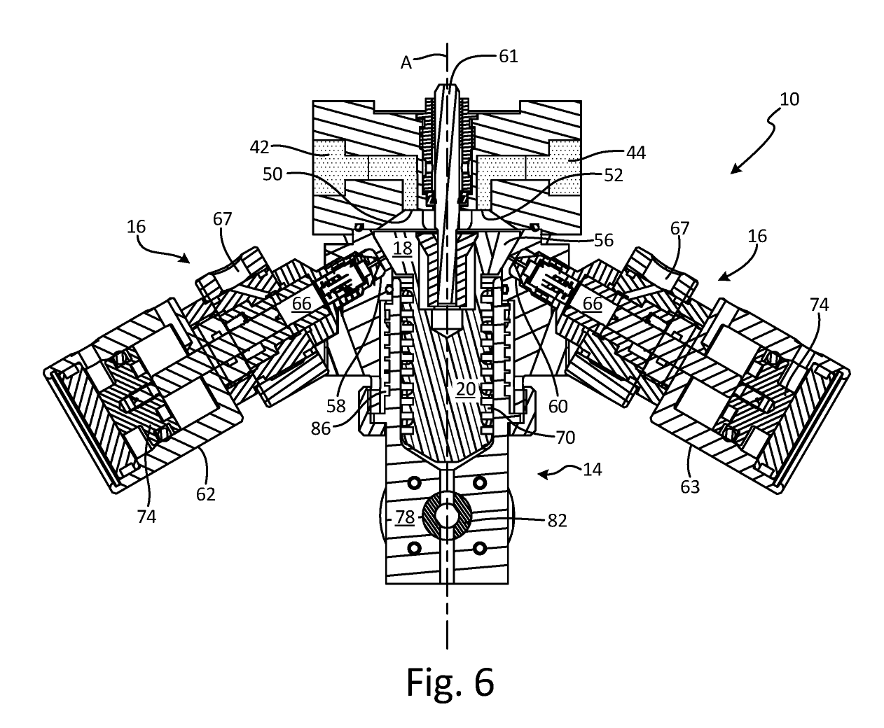

As shown in FIGS. 4 and 5, rotary gas diffuser 18 can be an annular member having a plurality of teeth 54 distributed about an outer circumference. FIG. 4 is a top cross-sectional view of a portion of apparatus 10 where gas 32 is injected into dispensing nozzle 14. FIG. 5 is a perspective view of rotary gas diffuser 18 and rotary mixer 20 shown in isolation. Teeth 54 can be separated by slots 56 open to the outer circumference. Slots 56 can be configured to segment flows of combined material 30L into discrete portions of a relatively small volume into which gas 32 can be injected. Slots 56 can extend parallel to axis of rotation A, can extend a full thickness of rotary gas diffuser 18 (e.g., axial thickness), and can have a uniform cross-section through the full thickness of rotary gas diffuser 18. In other embodiments, such as shown in FIG. 6, rotary gas diffuser 18 can be a frustoconical-shaped member having slots 56 angled from top to bottom inward toward axis of rotation A. In other embodiments, teeth 54 and slots 56 can have other configurations, such as curved shapes. It will be understood by one having ordinary skill in the art to adjust the volume, depth d₁, surface area, or shape of slots 56 to achieve a desired interaction between gas 32 and combined material 30L.

As shown in FIGS. 3 and 4, gas 32 can be injected into the discrete portions of combined material 30L in slots 56 through one or more gas outlets 58 and 60, opening to mixing channel 24 and directed to the outer circumference of rotary gas diffuser 18. Teeth 54 of rotary gas diffuser 18 can interrupt a flow of gas 32 as rotary gas diffuser 18 rotates about axis of rotation A on rotor 61 and teeth 54 pass along gas outlets 58 and 60. A gas-tight seal can be formed between teeth 54 and adjacent housing portion 57 of dispensing nozzle 14 as teeth 54 contact adjacent housing portion 57. Rotary gas diffuser 18 can be made of a deformable material, such as Teflon® or Rulon®, which can allow teeth 54 to deflect or deform under an applied force. Because rotary gas diffuser 18 is made of a deformable material, rotary gas diffuser 18 can have a larger diameter than an inner diameter of housing portion 57 in which it is positioned. A tight fit between rotary gas diffuser 18 and adjacent inner housing portion 57 can create a gas-tight seal between teeth 54 and adjacent inner housing portion 57, while the ability of teeth 54 to deflect can allow rotary gas diffuser 18 to spin. The gas-tight seal between teeth 54 and housing portion 57 allows teeth 54 to clip the larger bubble of gas 32 injected from positive displacement pump 16. In an alternative embodiment, such as shown in FIG. 6, rotary diffuser 18 can have a frustoconical shape fitted to adjacent housing portion 57. A force of combined material 30L can axially bias rotary gas diffuser 18 against housing portion 57 to create a seal between teeth 54 and housing portion 57. As rotary gas diffuser 18 rotates within housing portion 57, teeth 54 can clip a larger bubble of gas 32 into smaller gas bubbles 33. The size of the smaller gas bubbles 33 formed can depend on a number and size of teeth 54, rotational speed of rotary gas diffuser 18, and gas injection duration. In some instances, rotary gas diffuser 18 can break larger bubbles of gas 32 into microbubbles 34, having an average diameter of less than one millimeter. The smaller gas bubbles 33 can be produced as the rotational speed of rotary gas diffuser 18 and number of teeth 54 increase and the gas injection duration is reduced. In one embodiment, rotary gas diffuser 18 can have 20 teeth 54 and can rotate at approximately 1000 rpm. When gas 32 is injected from one of the gas outlets 58 or 60 over a period of 200 milliseconds, rotary gas diffuser 18 can clip a single large bubble of gas 32 into 66.66 smaller bubbles 33. Rotation of rotary gas diffuser 18, and more particularly, attached rotary mixer 20, can produce heat, which can cause materials 30L to react prematurely. Therefore, it may be desirable to reduce the speed at which rotary gas diffuser 18 rotates. Although material 30X can be cooled in dispensing nozzle 14, high speeds, for example, above 3000 rpm, can produce an amount of heat that makes cooling prohibitive. It will be understood by one of ordinary skill in the art that the rotational speed of rotary gas diffuser 18, number and size of teeth 54, and duration of gas injection can be adjusted as appropriate for varying applications or variations in materials or operating parameters (e.g., material viscosity, gas pressure, desired dispensing rate, etc.). Additional parameters, e.g., gas outlets 58 and 60 orifice size, injection pressure, and shape of teeth, can also be modified to achieve the desired number and size of smaller gas bubbles 33.

A predetermined amount of gas 32 can be injected into mixing channel 24 by positive displacement pump 16. As shown in FIGS. 3 and 4, positive displacement pump 16 can be a reciprocating positive displacement pump having cylinders 62 and 63. As shown in FIGS. 3 and 4, positive displacement pump can have gas outlet 58 from cylinder 62 and gas outlet 60 from cylinder 63. Gas outlets can be positioned 180 degrees from each other relative to axis of rotation A. Although the 180 degree spacing of outlets 58 and 60 shown in FIGS. 3 and 4 is intended to provide even distribution of gas 32 injection, the positioning of gas outlets 58 and 60 can be modified. Furthermore, additional (or fewer) cylinders can be used and additional gas outlets can be arranged around the outer circumference of rotary gas diffuser 18. In operation, gas 32 can be injected through outlets 58 and 60 in an alternating fashion as gas 32 can be supplied to positive displacement pump 16 on an intake side while being released into mixing channel 24 on a discharge side. The use of positive displacement pump 16 allows a user to control an amount of gas 32 injected into combined material 30L. Positive displacement pump 16 is slave to a main pressure of combined material 30L in mixing channel 24, injecting the predetermined amount of gas 32 only when a pressure of gas 32 reaches a pressure of combined material 30L in mixing channel 24 (or more specifically, in discrete portions in slots 56). The amount of gas 32 injected into mixing channel 24 can be adjusted by adjusting a pressure of gas 32 supplied to injection chamber 66 on the gas intake side of positive displacement pump 16 or by adjusting a cycle time (frequency of injection).

As shown in FIG. 3, gas 32 can be supplied to injection chamber 66 through inlet 67 from a variable pressurized gas source 68 (FIG. 1). Injection chamber 66 can have a defined volume prior to injecting gas 32 into mixing channel 24. Gas 32 entering injection chamber 66 through inlet 67 can be at a pressure less than the pressure of combined material 30L in mixing channel 24 to prevent continuous flow of gas 32 into mixing channel 24. Check valves 69 prevent the higher-pressure liquid material in mixing chamber 24 from entering positive displacement cylinders 62 and 63. As piston 74 translates, the volume of injection chamber 66 is reduced and gas 32 contained in injection chamber 66 is compressed. When the pressure of gas 32 in injection chamber 66 reaches the pressure of combined material 30L in mixing channel 24, gas 32 is released into mixing channel 24. For example, in one embodiment, injection chamber 66 can have a volume of 0.308 cubic centimeters with gas entering injection chamber 66 at 20 psi and material pressure in mixing channel 24 at 70 psi (483 kPa). In this case, gas 32 will not be released into mixing chamber until gas 32 has been compressed to a pressure of 70 psi. A compressed volume of gas 32 in mixing channel 24 would be 0.114 cubic centimeters. Once dispensed into atmospheric conditions as material 30X, gas 32 would expand to 0.845 cubic centimeters. The predetermined amount of gas 32 injected into mixing channel 24 can be varied by increasing or decreasing the pressure of gas 32 entering injection chamber 66 or by increasing or decreasing the cycle time of positive displacement pump 16. Lower and upper limits can define a range of the amount of gas injected into combined material 30L. Lower limits are generally set by the power factor positive displacement pump 16 and the pressure of gas 32 at inlet 67 (and injection chamber 66), e.g., positive displacement pump 16 may not be able to compress a low pressure gas 32 in gas injection chamber 66 enough to reach the pressure of combined material 30L. Upper limits are generally determined by the material's ability to hold gas. The ability to change the amount of the gas is necessary to maintain a consistent volume of gas microbubbles 34 with changes in materials 30A and 30B and material flow rates. The amount of gas injected (e.g., as determined by volume of injection chamber 66 and the pressure of gas 32 at inlet 67) can vary proportionately with the flow rate of material 30X from dispensing nozzle 14. For instance, as flow rate increases, additional gas 32 must be injected in proportion to the flow rate increase to maintain a consistent volume of gas microbubbles 34.

Once gas 32 has been injected into the discrete portions of combined material 30L in rotary diffuser 18, the resulting material 30X can flow through rotary mixer 20, positioned downstream of rotary gas diffuser 18. Rotary mixer 20 can have a wide variety of shapes (e.g., paddle, screw, disks, etc.), each of which function to mix material 30X and form microbubbles 34. In one embodiment, shown in FIGS. 3 and 5, rotary mixer 20 can have a series of annular flanges or disks 70 extending outward from a central stem portion 72 of rotary mixer 20 and separated by annular slots 74. As shown in FIG. 5, each disk 70 can have a plurality of cutouts 76 opening to an outer disk circumference through which material 30X can flow. Rotary mixer 20 can function to mix material 30X and form and evenly distribute gas microbubbles 34 throughout the material 30X. In one embodiment, gas microbubbles 34 can have an average width (e.g., diameter) between 50 μm and 400 μm. As shown in FIGS. 3 and 5, rotary mixer 20 and rotary gas diffuser 18 can be functionally different sections of a single (e.g., monolithic) part rotating about axis of rotation A. Therefore, rotary mixer 20 can rotate at the same speed as rotary gas diffuser 18. As shown in FIG. 5, a depth (d₂) of slots 74 between disks 70 can equal a depth (d₁) of slots 56 on rotary gas diffuser 18. Cutouts 76 on each disk 70 can be angled relative to axis of rotation A and can be positioned such that cutouts 76 on adjacent disks 70 are aligned. In the embodiment shown in FIG. 3, rotary mixer 20 can narrow from an upper section to a lower section (e.g., in a stepwise manner) to accommodate a narrowing mixing channel 24 toward dispensing nozzle 22. In this embodiment, both an outer diameter of stem portion 72 and outer diameter of disks 20 are smaller in the lower section than in the upper section. Lower section disks 20 can also have a plurality of cutouts 76, which can be angled relative to axis of rotation A. As shown in the embodiment disclosed in FIG. 5, cutouts 76 on the upper section of rotary mixer 20 can be angled in a different direction than cutouts 76 on the lower section of rotary mixer 20 to improve mixing. In an alternative embodiment, shown in FIG. 6, rotary mixer 20 can have a single section with disks 70 having a uniform diameter. As shown in both FIGS. 3 and 6, rotary mixer 20 can be housed in vessel 78. Inner edges 80 of vessel 78, forming an outer boundary of mixing channel 24, can be curved to improve material flow through mixing channel 24.

As shown in FIG. 3, vessel 78 can house rotary mixer 20, dispensing channel 28, including on/off valve 82, and interchangeable exit port housing 83. Material 30X can flow from mixing channel 24 through dispensing channel 28. On/off valve 82 can be used to control dispensing of material 30X. On/off valve 82 can be closed between applications to reduce material waste. As shown in FIG. 3, on/off valve 82 can be a non-displacement-type valve, which can be preferable for applications that require regular starting and stopping, as non-displacement-type valves do not displace material from dispensing channel 28 each time dispensing channel 28 is closed and are less likely to disrupt flow of material 30X from dispensing channel 28 when dispensing channel 28 is opened. Displacement-type valves, in contrast, can cause bead 36 to widen or shrink depending on the type of displacement valve utilized. When on/off valve 82 is open, material 30X can flow through interchangeable exit port housing 83. Interchangeable exit port housing 83 can be located at an outer end of vessel 78 in nozzle tip 22. Interchangeable exit port housing 83 can be fastened to vessel 78 in nozzle tip 22 by a fastening mechanism, such as threaded engagement (e.g., retaining nut 84), allowing for removal and replacement of interchangeable exit port housing 83. Interchangeable exit port housings 83 can provide varying orifice sizes to accommodate varying applications.

One or more cooling plenums 86 and 88, confined by outer nozzle housing 90, can surround a portion of vessel 78 to slow a reaction of mixed material 30X in dispensing nozzle 14. Heat produced by spinning rotary gas diffuser 18 and rotary mixer 20 can cause material 30X to react in dispensing nozzle 14. Such reaction can cause undesirable skinning or hardening of material 30X in mixing channel 24 and dispensing channel 28, which can interfere with material dispensing. An external source of cooling fluid can be provided to cooling plenums 86 and 88 to limit or prevent the reaction of material 30X in dispensing nozzle 14. In one embodiment, as disclosed in FIG. 3, two cooling plenums 86 and 88 can surround portions of vessel 78. Cooling plenum 86 can surround a portion of vessel 78 housing rotary mixer 20, while cooling plenum 88 can surround a portion of vessel 78 housing dispensing channel 28. In an alternative embodiment, a single cooling plenum can be used. It will be understood by one of ordinary skill in the art that one or more cooling plenums can be arranged as appropriate to provide cooling to the entire vessel 78, including mixing channel 24, dispensing channel 28, on/off valve 82, and interchangeable exit port housing 83. Vessel 78 can made of a thermally conductive material (e.g., C145 copper) to sufficiently remove heat produced by rotary gas diffuser 18 and rotary mixer 20. Cooling inlets and outlets (not shown) can be used to circulate the cooling fluid through cooling plenums 86 and 88. Cooling fluids can include various liquid and gaseous fluids known in the art. Cooling material 30X below a temperature at which the material reaction occurs can increase a dwell time or time material 30X can remain in dispensing nozzle 14 without reacting. Increasing the dwell time can reduce waste of combined material 30X—material that would otherwise have to be purged from dispensing nozzle 14 between applications prior to hardening or thickening of material 30X.

Apparatus 10 can provide direct metering of gas 32 at the point of dispensing thereby providing a consistent foam structure and material density that can be adjusted as necessary to accommodate varying applications as well as changes in materials and material flow rate. Rotary gas diffuser 18 can be used to break larger bubbles of gas 32 into smaller gas bubbles 33, which can be entrained in one or more liquid materials 30L, while rotary mixer 20 can form and evenly distribute gas microbubbles 34 and mix reactive materials 30X. Although apparatus 10 can be used for a wide variety of applications and materials, the production of gas microbubbles 34 is particularly desirable for the preparation of materials dispensed in small volumes, such as a bead of adhesive, where larger gas bubbles would render the material useless. Additionally, the injection of gas 32 into mixing channel 24, having both materials 30A and 30B (as combined material 30L), can eliminate the need to adjust a ratio of materials 30A and 30B based on the amount of gas 32 injected, which would be necessary if gas 32 was injected into only one of materials 30A and 30B.

### Discussion of Possible Embodiments

The following are non-exclusive descriptions of possible embodiments of the present invention.

An apparatus for preparing a liquid material containing microbubbles includes a dispensing nozzle and a first positive displacement gas pump. The dispensing nozzles includes a material mixing channel, a rotary gas diffuser positioned in the material mixing channel, and a rotary mixer positioned in the material mixing channel downstream of the rotary gas diffuser. The rotary gas diffuser and the rotary mixer rotate about a common axis of rotation. The first positive displacement pump has a first gas outlet opening to the material mixing channel, which is directed at an outer circumference of the rotary gas diffuser.

The apparatus of the preceding paragraph can optionally include, additionally and/or alternatively, any one or more of the following features, configurations and/or additional components:

A further embodiment of the foregoing apparatus can further comprise a second gas outlet opening to the material mixing channel and directed at an outer circumference of the rotary gas diffuser. The second gas outlet can be positioned 180 degrees from the first gas outlet relative to the common axis of rotation.

A further embodiment of the foregoing apparatus, wherein the positive displacement gas pump can be a reciprocating positive displacement gas pump having two cylinders.

A further embodiment of the foregoing apparatus, wherein gas can be injected through first and second gas outlets in an alternating fashion.

A further embodiment of the foregoing apparatus, wherein the rotary gas diffuser can be an annular member having a plurality of teeth distributed about the outer circumference with the teeth being separated by slots through which the liquid material flows. A further embodiment of the foregoing apparatus, wherein the rotary gas diffuser rotates at a speed less than 3000 rpm.

A further embodiment of the foregoing apparatus, a seal can be formed between the plurality of teeth and an adjacent housing of the dispensing nozzle.

A further embodiment of the foregoing apparatus, wherein the rotary mixer can further include a first series of disks, each disk having a plurality of cutouts opening to a first disk circumference.

A further embodiment of the foregoing apparatus can further include a first material outlet for delivering a first liquid material to the dispensing nozzle, and a second material outlet for delivery a second liquid material to the dispensing nozzle. The first and second material outlets can open to the material mixing channel directly upstream of the rotary gas diffuser and can be configured to dispense the first and second liquid materials into the slots of the rotary gas diffuser.

A further embodiment of the foregoing apparatus, wherein the dispensing nozzle can further include a cooling plenum confined by an outer housing of the dispensing nozzle, wherein the cooling plenum surrounds at least a portion of the rotary mixer and contains a cooling medium.

A further embodiment of the foregoing apparatus, wherein the dispensing nozzle can further include a nozzle tip downstream of the material mixing channel, a material dispensing channel, and a valve configured to control material flow through the material dispensing channel. The nozzle tip can have a material inlet aligned with a material outlet of the material mixing channel. The material dispensing channel can extend from the inlet through the nozzle tip.

A further embodiment of the foregoing apparatus, wherein the nozzle tip can further include further an interchangeable exit port housing located at an outer end of the nozzle tip. The interchangeable exit port housing can be fastened to the nozzle tip by a fastening mechanism allowing for removal and replacement of the interchangeable exit port housing.

A method of preparing and applying a liquid material containing microbubbles includes delivering a first liquid material into a common material mixing channel of a dispensing nozzle, segmenting the first liquid material into discrete portions by flowing the first liquid material through slots, injecting a predetermined amount of gas into the discrete portions of the first liquid material in the slots of the rotary gas diffuser, and mixing the first liquid material and the gas in the dispensing nozzle.

The method of the preceding paragraph can optionally include, additionally and/or alternatively, any one or more of the following steps, features, configurations and/or additional components:

A further embodiment of the foregoing method can further include breaking large bubbles of the gas into smaller bubbles by spinning the rotary gas diffuser while injecting the gas, entraining the smaller bubbles of the gas in the first liquid material, and forming microbubbles of gas by spinning a rotary mixer.

A further embodiment of the foregoing method, wherein injecting a predetermined amount of gas into the first liquid material can include injecting the gas at a first location of the dispensing nozzle adjacent an outer circumference of the rotary gas diffuser, and injecting the gas at a second location of the dispensing nozzle adjacent an outer circumference of the rotary gas diffuser. The second location can be 180 degrees from the first location, and the injection of gas can alternate between the first location and the second location.

A further embodiment of the foregoing method can further include adjusting the amount of gas injected into the liquid material by adjusting a pressure of the gas in an injection chamber of a positive displacement pump.

A further embodiment of the foregoing method can further include delivering a second liquid material into the common material mixing channel, entraining the smaller bubbles of the gas in the second liquid material, mixing the first and second liquid materials and the gas in the dispensing nozzle, and forming microbubbles of gas in the mixed first and second liquid materials. The first and second liquid materials can be different and can be delivered into the common material mixing channel simultaneously.

A further embodiment of the foregoing method can further include cooling the first and second liquid materials in the dispensing nozzle.

A further embodiment of the foregoing method, wherein mixing the first liquid material and the gas in the dispensing nozzle can include flowing the first liquid material, having entrained microbubbles of the gas, through a rotary mixer downstream of the rotary gas diffuser.

A further embodiment of the foregoing method can further include dispensing a bead of the first liquid material, having the entrained microbubbles of the gas, onto a surface, wherein an average width of the microbubbles of the gas is less than one millimeter.

### SUMMATION

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An apparatus for preparing a liquid material containing microbubbles, the apparatus comprising:
a dispensing nozzle comprising:
a material mixing channel;
a rotary gas diffuser positioned in the material mixing channel; and
a rotary mixer positioned in the material mixing channel downstream of the rotary gas diffuser, wherein the rotary gas diffuser and the rotary mixer rotate about a common axis of rotation; and
a positive displacement gas pump having a first gas outlet opening to the material mixing channel, wherein the first gas outlet is directed at an outer circumference of the rotary gas diffuser.

2. The apparatus of claim 1, and further comprising:
a second gas outlet opening to the material mixing channel and directed at an outer circumference of the rotary gas diffuser, wherein the second gas outlet is positioned 180 degrees from the first gas outlet relative to the common axis of rotation.

3. The apparatus of claim 2, wherein the positive displacement gas pump is a reciprocating positive displacement gas pump having two cylinders.

4. The apparatus of claim 3, wherein gas is injected through first and second gas outlets in an alternating fashion.

5. The apparatus of claim 1, wherein the rotary gas diffuser comprises an annular member having a plurality of teeth distributed about the outer circumference, the teeth being separated by slots through which the liquid material flows.

6. The apparatus of claim 5, wherein rotary gas diffuser rotates at a speed less than 3000 rpm.

7. The apparatus of claim 6, wherein a seal is formed between the plurality of teeth and an adjacent housing of the dispensing nozzle.

8. The apparatus of claim 1, wherein the rotary mixer comprises:
a first series of disks, each disk having a plurality of cutouts opening to a first outer disk circumference.

9. The apparatus of claim 8, and further comprising:
a first material outlet for delivering a first liquid material to the dispensing nozzle; and
a second material outlet for delivery a second liquid material to the dispensing nozzle, wherein the first and second material outlets open to the material mixing channel directly upstream of the rotary gas diffuser and are configured to dispense the first and second liquid materials into the slots of the rotary gas diffuser.

10. The apparatus of claim 1, wherein the dispensing nozzle further comprises:
a cooling plenum confined by an outer housing of the dispensing nozzle, wherein the cooling plenum surrounds at least a portion of the rotary mixer and contains a cooling medium.

11. The apparatus of claim 4, wherein the dispensing nozzle further comprises:
a nozzle tip downstream of the material mixing channel, the nozzle tip having a material inlet aligned with a material outlet of the material mixing channel;
a material dispensing channel extending from the inlet through the nozzle tip; and
a valve configured to control material flow through the material dispensing channel.

12. The apparatus of claim 11, wherein the nozzle tip further comprises:
an interchangeable exit port housing located at an outer end of the nozzle tip, the interchangeable exit port housing being fastened to the nozzle tip by a fastening mechanism allowing for removal and replacement of the interchangeable exit port housing.

13. A method of preparing and applying a liquid material containing microbubbles, the method comprising:
delivering a first liquid material into a common material mixing channel of a dispensing nozzle;
segmenting the first liquid material into discrete portions by flowing the first liquid material through slots;
injecting a predetermined amount of gas into the discrete portions of the first liquid material in the slots of the rotary gas diffuser; and
mixing the first liquid material and the gas in the dispensing nozzle.

14. The method of claim 13, and further comprising:
breaking large bubbles of the gas into smaller bubbles of gas by spinning the rotary gas diffuser while injecting the gas;
entraining the smaller bubbles of gas in the first liquid material; and
forming microbubbles of gas by spinning a rotary mixer.

15. The method of claim 14, wherein injecting a predetermined amount of gas into the first liquid material comprises:
injecting the gas at a first location of the dispensing nozzle adjacent an outer circumference of the rotary gas diffuser; and
injecting the gas at a second location of the dispensing nozzle adjacent an outer circumference of the rotary gas diffuser, wherein the second location is 180 degrees from the first location, and wherein the injection of gas alternates between the first location and the second location.

16. The method of claim 14, and further comprising:
adjusting the amount of gas injected into the liquid material by adjusting a pressure of the gas in an injection chamber of a positive displacement pump.

17. The method of claim 14, and further comprising:
delivering a second liquid material into the common material mixing channel, wherein the first and second liquid materials are different and wherein the first and second liquid materials are delivered into the common material mixing channel simultaneously;
entraining the smaller bubbles of gas in the second liquid material;
mixing the first and second liquid materials and the gas in the dispensing nozzle; and
forming microbubbles of gas in the mixed first and second liquid materials.

18. The method of claim 17, and further comprising:
cooling the first and second liquid materials in the dispensing nozzle.

19. The method of claim 14, wherein mixing the first liquid material and the gas in the dispensing nozzle comprises:
flowing the first liquid material, having entrained microbubbles of the gas, through a rotary mixer downstream of the rotary gas diffuser.

20. The method of claim 19, and further comprising:
dispensing a bead of the first liquid material, having the entrained microbubbles of the gas, onto a surface, wherein an average width of the microbubbles of the gas is less than one millimeter.
